(19) United States
(12) Patent Application Publication
(10) Pub. No.: US 2022/0252093 A1
(43) Pub. Date: Aug. 11, 2022

(54) Alignment Aid for Screens

(71) Applicant: Bohnen IT GmbH, Wuppertal (DE)

(72) Inventor: Jonas Bohnen, Wuppertal (DE)

(21) Appl. No.: 17/614,171

(22) PCT Filed: Apr. 22, 2020
(86) PCT No.: PCT/EP2020/061215

§ 371 Date: Nov. 24, 2021

(30) Foreign Application Priority Data
May 24, 2019 (DE) 10 2019 113 924.4

(51) Int. Cl. F16B 1/00; G06F 1/16

(52) U.S. Cl. CPC F16B 1/00; F16B 2001/0035; G06F 1/1601

(57) ABSTRACT

The invention relates to an alignment aid for screens, including at least one first connecting means of a first type, and at least one second connecting means of a second type, the first connecting means of a first screen and the second connecting means of a second screen cooperating with each other for alignment of the screens relative to each other.

### CROSS-REFERENCE TO RELATED APPLICATIONS

This application is the United States national phase of International Application No. PCT/EP2020/061215 filed Apr. 22, 2020, and claims priority to German Patent Application No. 10 2019 113 924.4 filed May 24, 2019, the disclosures of which are hereby incorporated by reference in their entirety.

### BACKGROUND OF THE INVENTION

### Field of the Invention

The invention relates to an alignment aid for screens.

### Description of Related Art

Today, two or more screens are often used at the workplace. This allows several programs or documents to be edited simultaneously. This is particularly helpful in programming, for technical drawing or editing databases.

The alignment of the individual screens in their height, their inclination and in their distance to the user is essentially carried out via the screen base or the articulated arm attached to the screen.

However, the alignment of the screens to each other often proves to be problematic. Exact parallel alignment of the screen edges to each other is difficult with the means known in the prior art. Moreover, the alignment is often not permanent if something shifts when the screen is cleaned or it is bumped against the desk or screen. In addition to being a purely aesthetic disadvantage for the user, insufficient stability of the alignment may also be ergonomically disadvantageous. It leads to gaps between the edges of the screen, through which disturbing light enters and blinds the user. Light reflections on the screens subsequently lead to incorrect data editing and/or health impairments.

Although it is already known from the prior art to mount several screens on a so-called monitor arm, these require a permanent and therefore a fixed connection to the wall or desk, they must be firmly connected (e.g. via screw connections) to the screens and also take up valuable space. Aligning different screens mounted on a common monitor arm to each other is also not easy.

### SUMMARY OF THE INVENTION

Therefore, in order to overcome the above mentioned disadvantages, it is the object of the invention to provide an aid which enables the alignment of two or more screens with respect to each other in a simple manner at the workplace, so that touching or accidental vibration does not change the alignment of the screens.

The object is solved by the alignment aid for screens, comprising the features as described herein, in particular comprising at least one first connecting means of a first type, and at least one second connecting means of a second type, the first connecting means of a first screen and the second connecting means of a second screen cooperating with each other for alignment of the screens relative to each other.

The alignment aid according to the invention is of particular advantage in the case of fixed screens at the workplace or also any other fixed monitors, such as television monitors. In particular, screens with frameless display surfaces can be easily arranged next to each other or on top of each other without a gap. By the interaction of the first and second connecting means with each other, the outer edges of the screens lie securely next to each other, even if the screens or their surface on which they are positioned are shaken. In a simple manner, the alignment aid according to the invention can be used to arrange further screens on the already existing ones.

The almost seamless arrangement of the screens with respect to one another not only improves the aesthetics of the work, but above all significantly improves the ergonomics of the work. The alignment aid according to the invention allows the vertical or horizontal outer edges of the screens to be positioned so precisely relative to one another that the comparison of data lines, table fields or drawings is simplified. The eye does not have to overcome an “obstacle” in the form of a gap between the screens; moreover, it is not affected by changing light conditions.

Preferably, the alignment aid according to the invention is formed such that the connecting means are cooperating with each other in a contactless manner. This means that the connecting means may also be accommodated within the screen housing and do not extend outwardly. In this way, the screens can be in seamless contact with each other.

According to one embodiment of the invention, the first connecting means is a first magnet and the second connecting means is a magnetic material cooperating with the magnet, such as a magnetic metal. A magnetic connection of the outer edges of two screens via the alignment aid according to the invention is of particular advantage, as it is sufficiently stable and thus robust enough to counteract vibration or accidental displacement of the screens, but it can be released again in a simple manner without tools.

According to the invention, it is also possible that the first connecting means is a first magnet and that the second connecting means is also a magnet and that the magnets are arranged on the respective screen in such a way that the magnets face each other with unequal polarity. In this manner, the screens can be arranged with respect to each other only in a predetermined orientation and order. An upside-down arrangement or twisting of the screens is thus avoided. The alignment aid is thus particularly easy to use and error-free.

According to the invention, it may also be provided that the connecting means are mechanical connecting means.

Thus, according to one embodiment of the invention, it is conceivable that the first connecting means is an extension and the second connecting means is a recess in which the extension engages for aligning coupling of the screens. In this embodiment according to the invention, it is also ensured that the screens can be connected to one another only in a specific orientation relative to one another. The extension and recess are arranged in such a way that they align the screens vertically or horizontally exactly with respect to each other when they engage correctly with each other.

The extension and recess are formed to complement each other in such a way that they engage with each other but do not become detached in the event of slight vibrations or impacts against the screens.

According to the invention, the first and second connecting means may comprise latching means which fix the connecting means to each other. These may, for example, be clip elements made of plastic, which are arranged in such a way that, when the screens are correctly oriented relative to one another, they lock in position under gentle pressure. According to the invention, these latching means are also configured such that pivoting of the screens about the longitudinal axis of the alignment aid is possible to a certain extent.

According to a further embodiment of the invention, the connecting means are arrangeable as complementary components on the respective screen. According to the invention, it is conceivable that the alignment aid is in the form of a pair of rails or strips. In an advantageous manner, screens can thus be subsequently provided with the alignment aid according to the invention. This also enables the screens to be rearranged quickly and easily. According to the invention, there are several possibilities for equipping the alignment aid, which is formed as a separate component, with connecting means.

Thereby, it is conceivable that the connecting means are arrangeable on the respective screen in a frictional and/or positive-locking manner. The connecting means, for example in the form of a rail or strip, can thus be pushed onto the outer edge of the screen to be connected, clipped on or, in case of doubt, screwed or glued on.

According to the invention, it is provided that a screen with an alignment aid according to the invention carries at least one first and at least one second connecting means provided for cooperating with connecting means of a second screen of a same type.

Thus, the connecting means can be integrated into the screen, in particular into the frame of the screen. Particularly in the case of contactless connecting means, such as the above-mentioned magnets, it can be advantageous to integrate these directly into the screen or the frame of the screen.

For example, a screen having the alignment aid according to the invention comprises a first connecting means of a first type integrated into the left edge of the screen and a second connecting means of a second type integrated into the right edge of the screen. A screen equipped in this way can be connected to another screen having the same equipment. Both screens can be aligned with each other using the existing alignment aid. Such an arrangement is particularly advantageous for aesthetic reasons, but also from a technical point of view, since the screen surfaces, in particular in borderless embodiments, are in fact seamlessly adjacent to each other without further application of the alignment aid.

If necessary, the magnets are shielded from the display area of the screen and only act in the direction of the outer edge of the screen.

According to the invention, it is conceivable in the magnetic embodiment of the alignment aid according to the invention that the first connecting means and the second connecting means are each rod-shaped and are integrated into the edge of the screen parallel to an edge of the screen. Likewise, it is provided according to the invention to integrate several rod-shaped magnets aligned along a line in the screen edge. However, according to the invention, the shape of the magnets is by no means limited to rod-shaped magnets. According to the invention, it may be useful to also incorporate another form of magnets.

According to a further embodiment of the invention, the first and the second connecting means are arranged in such a way that, when a plurality of screens are arranged vertically or horizontally in a row, complementary connecting means of different screens face each other. According to the invention, an incorrect arrangement of the screens can thus be avoided if, for example, the first connecting means of the first type is always arranged at the right-hand edge of a screen, and the embodiment is such that the north pole of the magnet faces the outer edge of the screen, and the second connecting means of the second type is always arranged at the left-hand edge of a screen, and the embodiment is such that the south pole of the magnet faces the outer edge of the screen.

### BRIEF DESCRIPTION OF THE DRAWINGS

A better understanding of the invention, as well as further advantages, will be apparent from the following description of some embodiments.

It show in simplified representation:

FIG. 1 a first embodiment of the alignment aid according to the invention;

FIG. 2 a screen arrangement with the alignment aid shown in FIG. 1, the alignment aid being arranged in the form of separate clamping components on the screens;

FIG. 3 a screen arrangement with a further embodiment of the invention, wherein the alignment aids are integrated into the screen housing;

FIG. 4 a screen arrangement with a further embodiment of the invention, wherein the alignment aids are integrated into the screen housing;

FIG. 5 a top view of a screen arrangement as shown in FIG. 3 or 4;

FIG. 6 a partial illustration of an arrangement of a plurality of screens aligned both vertically and horizontally with respect to each other via the alignment aid according to the invention; and

FIG. 7 a screen arrangement of two screens with a further embodiment of the invention, wherein the screens are formed as mechanical connecting means.

### DESCRIPTION OF THE INVENTION

In the figures, an arrangement of a plurality of screens is altogether provided with the reference numeral 10. The respective arrangements 10 are held in a defined position relative to each other by means of various embodiments of the alignment aid according to the invention.

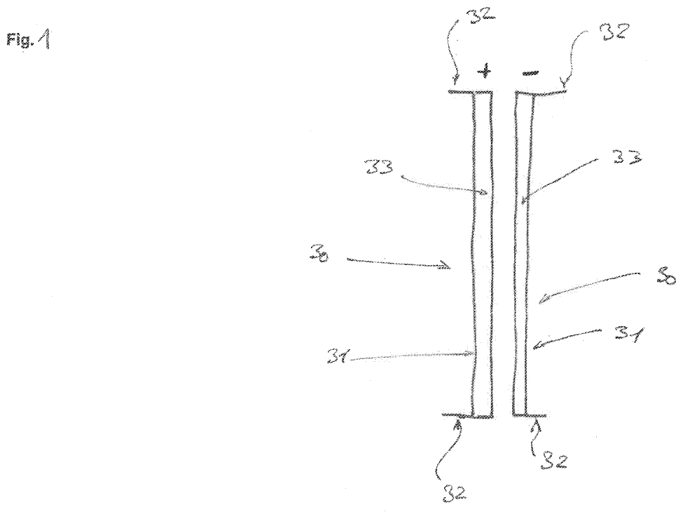

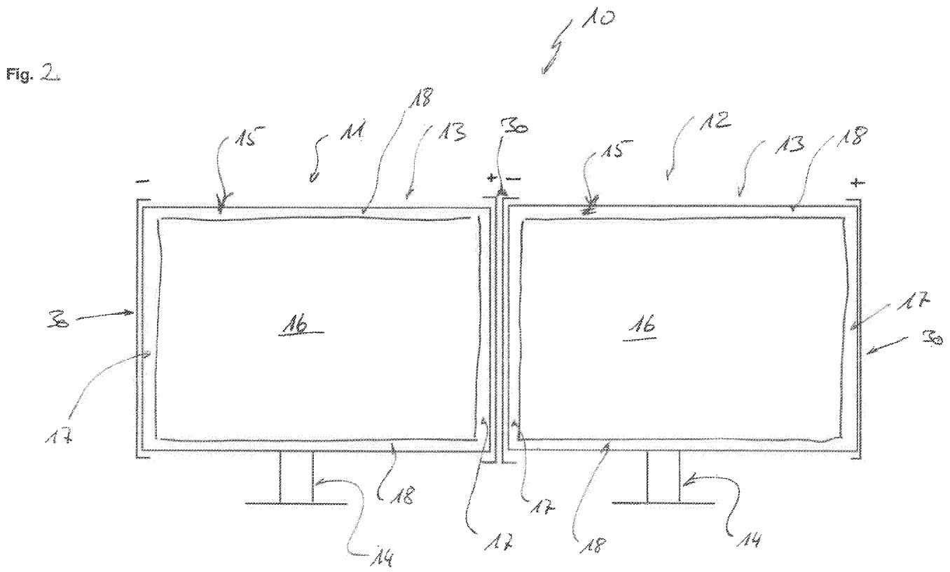

A first embodiment of the invention is shown in FIGS. 1 and 2. FIG. 2 shows a screen arrangement 10 comprising a first screen 11 and a second screen 12, each screen initially comprising a screen housing 13 supported by a screen base 14. In FIG. 2, the screens may be workstation screens for computers or television screens.

Each screen housing 13 forms a screen frame 15 surrounding a display surface 16 for displaying information. This screen frame 15 is overdrawn to clarify the invention. This is to be clarified in particular with regard to so-called frameless screens. In these, the screen frame 15 is reduced to an almost imperceptible dimension. In addition, there are now techniques in which the frame enclosing the display surface is concealed from view by the display unit. Nevertheless, even in the case of screens 11, 12 of the latter type, there is a frame in the broadest sense which holds the display unit providing the display surface in the housing.

Each screen frame 15 has a total of four frame legs, namely two vertical frame legs 17 and two horizontal frame legs 18 respectively.

As can be seen from FIG. 2, in the screen arrangement 10 shown there, the respective vertical frame legs 17 each carry a clamping component designated overall by the reference numeral 30. These clamping components 30 are part of the alignment aid according to the invention. Two cooperating clamping components 30 are shown in FIG. 1.

Each clamping component 30 initially comprises a clamping housing 31, each clamping housing having at its ends approximately horizontally directed clamping legs 32 with which the clamping component 30 can be fixed to the screen frame, as shown in FIG. 2.

In addition, the clamping housing 31 accommodates connecting means, here in the form of magnets 33 in the broadest sense of the term. In order for the magnets 33 to cooperate with each other, i.e. to attract each other, in order to align the screens 16 FIG. 2, they are aligned in a complementary manner with respect to their polarity. This is symbolized by the symbols “+” and “−” in FIGS. 1 and 2, respectively. A magnet 33 of one of the clamping components 30 thus represents the first connecting means of the first type. The other magnet 33 of the corresponding clamping component 30 thus represents the second connecting means of the second type. Two connecting means fundamentally suitable for cooperating with each other form the alignment aid according to the invention.

As FIG. 2 shows, in the screen arrangement 10 there, each screen carries two clamping components each with a magnet, the polarity of the magnets being complementary, i.e. each screen carries one magnet marked here with “+” and one marked with “−”. Thus, each screen 11/12 carries a first connecting means of the alignment aid and a second connecting means of the alignment aid.

When the first screen 11 and second screen 12 are to be brought together in an arrangement as shown in FIG. 1, these cooperating alignment aids are placed side by side. The magnetic forces caused by the magnets in FIG. 2 cause the respective clamp components and the frame sections connected to them to bear against each other. This creates a connection between the two screens. If a force is now exerted on one of the screens which loosens the alignment with respect to the other, for example by cleaning the screen or by a vibration of the workstation, the screens lose at most temporarily their arrangement imposed by the alignment aid, i.e. in FIG. 2 by the mutually corresponding clamping components 30. As a rule, the screens will automatically align themselves to each other, provided that they can be moved about a joint which is not shown.

Even if the screen is not automatically aligned with one another, only a small amount of adjustment is required by the user, since the alignment aid, in particular the cooperating connecting means, specifically the magnets in FIG. 2, automatically carry out the screen alignment as soon as they have been brought sufficiently close together.

The embodiment of the invention illustrated in FIGS. 1 and 2 and explained with reference to the associated description has the advantage that they can be retrofitted via the clamping components 30 of the alignment aid according to the invention, which are to be handled separately from the screen, and—with appropriate construction—could also be fixed to screens of different dimensions as clamping components 30 whose length can be variably adjusted. The fixing can be effected by clamping, but is not limited thereto according to the invention. In the same way, gluing on or, for example, fastening by means of Velcro elements is conceivable for the alignment aid to be retrofitted in accordance with the invention.

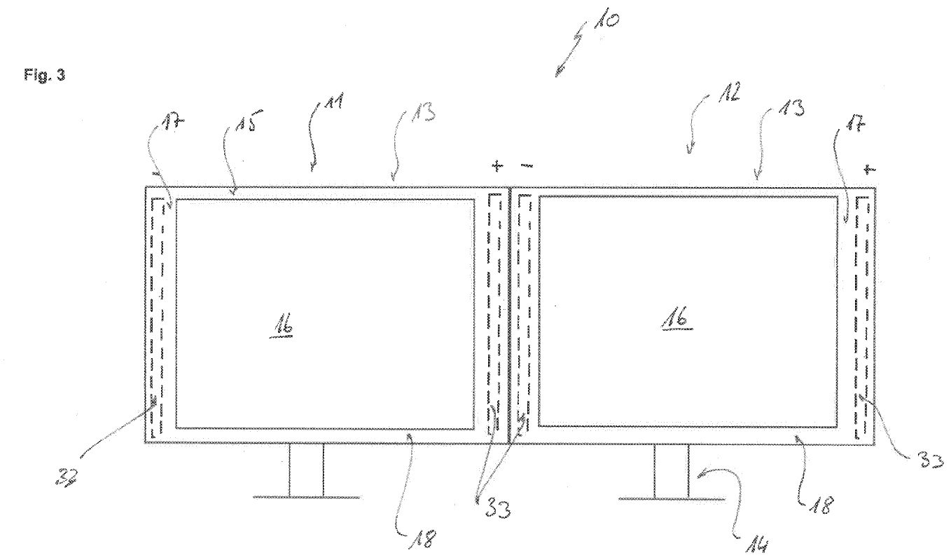

FIG. 3 shows a screen arrangement 10 which is similar in all essential features to that in FIG. 2. Only the alignment aid according to the invention is shown here in a different embodiment. The connecting means of the first type (the rod-shaped magnet 33 marked with a “+” symbol) and the connecting means of the second type (the rod-shaped magnet 33 marked with a “−” symbol) are here integrated in the screens 11 and 12 respectively, more precisely in the screen housing 13 here in each case in the vertical frame legs 17. For this reason, they are only shown with dashed lines.

The essential advantage of the present invention lies in its higher overall aesthetic impression. The function is identical to that of the first embodiment. Here, too, the screens 11 and 12, which are arranged next to one another, align themselves with one another as a result of the magnetic forces as soon as the screens are moved close enough to one another.

Overall, in each of the embodiments shown in FIGS. 1 to 3, the connecting means comprise rod-shaped or other elongated magnetic shapes.

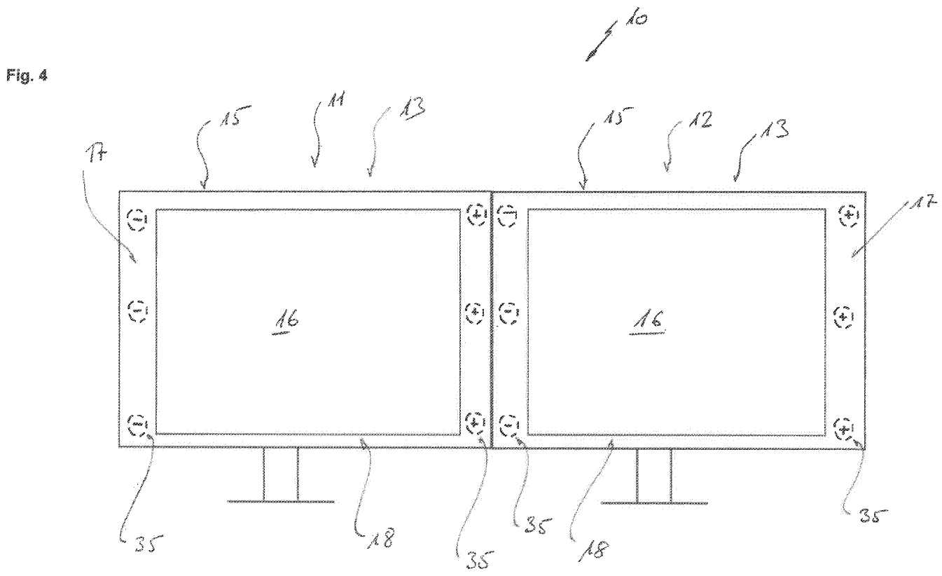

FIG. 4 shows another embodiment of the invention. Again, a screen arrangement comprising a first screen 11 and a second screen 12 is shown, all bearing the reference numeral 10. Here, the deviating embodiment of the first and second connecting means deserves attention. Here, magnets are again integrated into the respective vertical frame legs 17. However, these are individual magnets which are arranged at a distance from one another in the vertical direction.

The magnets designated here as 35 are in turn designated “+” and “−”, respectively, with respect to their complementary polarity. In this embodiment of the invention, there is an additional benefit compared to the two aforementioned embodiments. Here, the magnetic forces do not only act in a supporting manner in the horizontal direction to ensure the arrangement of the screens relative to each other. By using a plurality of magnets 35 arranged spaced apart from each other in the vertical direction, an alignment function acting in the vertical direction also takes place. In this respect, not only do adjacent vertical legs 17 of two screens 11, 12 lie exactly against each other. Due to the vertical alignment support, the horizontal frame legs 18 of the two screens 11 and 12 are also aligned with each other.

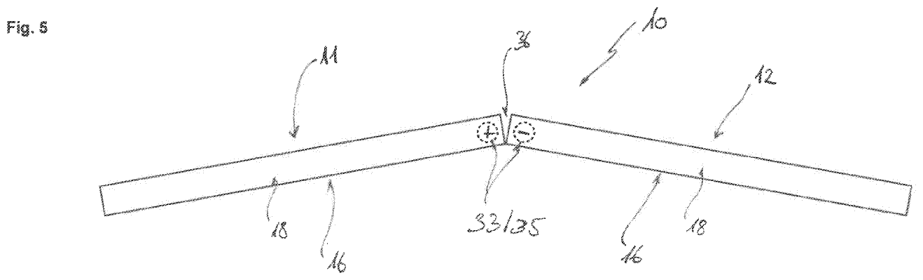

FIG. 5 shows a top view of a screen arrangement 10 as shown for example in FIG. 2, 3 or 4. This top view shows that the screens are arranged at an angle to each other about a mutual line of contact between the vertical frame legs 17, so that there is a gap between the vertical legs 17 of the screen frames 15. Even such an angular screen arrangement does not prevent the advantages of the alignment aid according to the invention, in particular if the magnets 33/35, which are merely schematically drawn in here, are integrated in the frame as far forward as possible, facing the viewer.

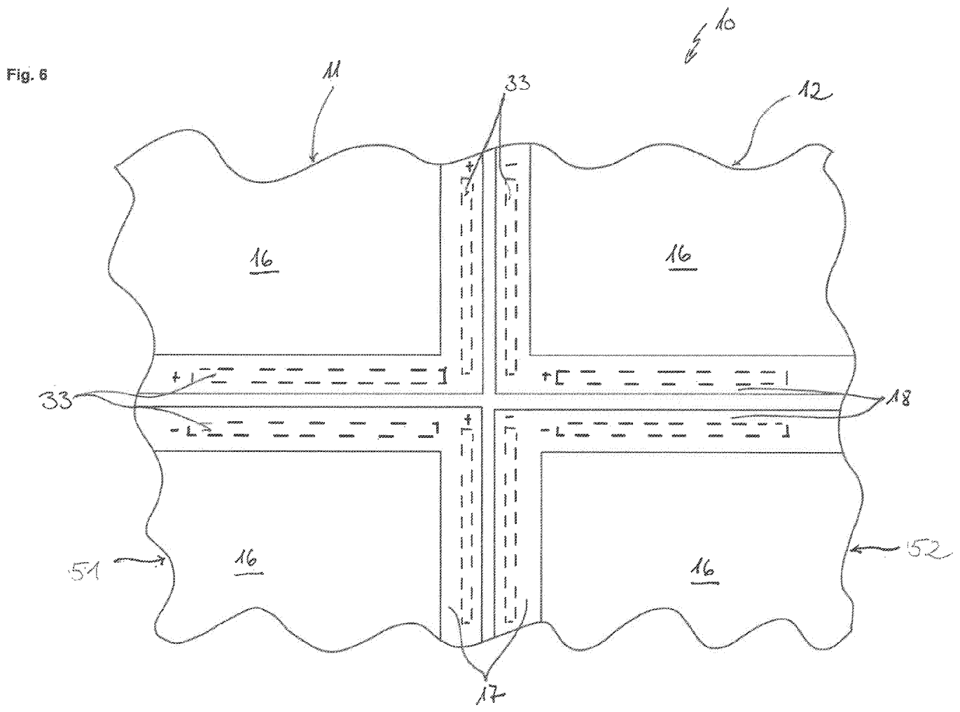

FIG. 6 illustrates a screen arrangement 10 shown in detail, e.g. such as used at large events. Here, several screens are connected horizontally next to each other and vertically above each other to form a single, correspondingly large display area. Here it is shown that the alignment aid is arranged not only in the region of the vertical legs 17 but also in the region of the horizontal legs 18 with first as well as second connecting means in the screen frames, which cooperate with one another in order to permanently and stably align four screens 11, 12, 51, 52 shown here in part with one another.

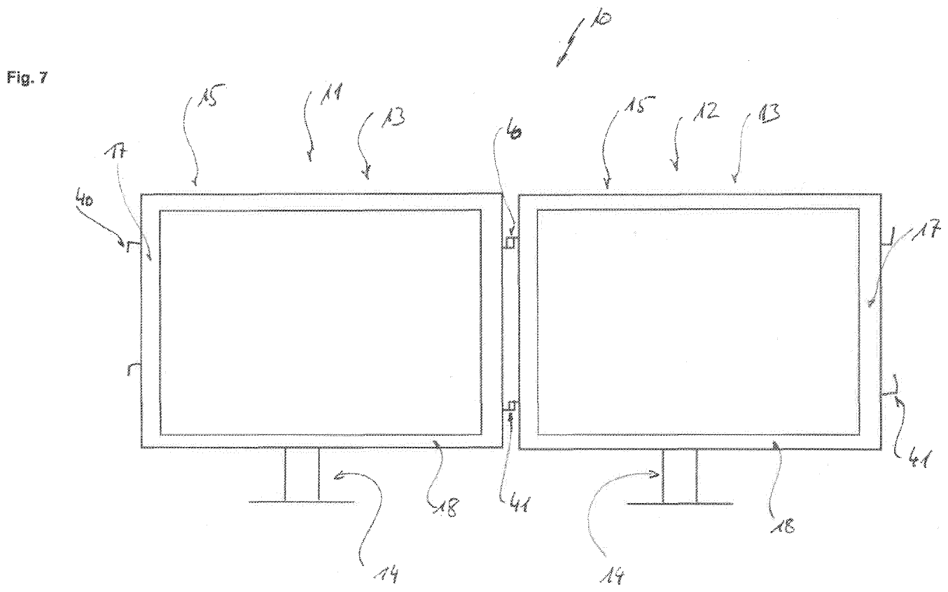

Finally, reference should be made to FIG. 7, which again shows an arrangement 10 of only two screens 11 and 12.

Again, the vertical legs 17 of the screens 11 and 12 have first connecting means and second connecting means which can form an alignment aid with each other. The first connecting means are formed here as first hooks 40, the second connecting means are formed as second hooks 41. The hooks of adjacent vertical legs 17 of two screens 11, 12 engage with one another in order to arrange the screens against one another horizontally and vertically and to align them securely with one another. The hooks 40 and 41 are schematically shown here. There is a gap between the screens 11 and 12 in which the engagement of the hooks 40 and 41 can be seen. It should be noted that this is an overdrawing. Of course, also in this case a seamless juxtaposition of the screens may be possible, so that a concealed arrangement of the hooks is ensured. In order to enable an angular arrangement of the screens 11 and 12 with respect to each other also in this embodiment of the invention, as already shown and described in FIG. 5, it is conceivable to make the hooks extendable under spring load.

FIG. 7 illustrates that the alignment aid may be formed by interlocking mechanical first connecting means and second connecting means.

As an alternative embodiment not shown in the illustration, it is conceivable, for example, that a textile fabric or another flat structure can be arranged on mutually facing frame legs 17, 18 of adjacent screens in order to connect them to one another. In this context, it is quite conceivable that the flat structure or textile fabric itself contains magnets or magnetic materials and can be reversibly arranged on the screen frame 15 via this.

The essential advantage of the invention, described in the aforementioned embodiment examples, is that the alignment aid can stabilize an arrangement of at least two or more screens with respect to one another or, to a certain extent, effect this independently. This results in a particularly advantageous, aesthetic overall impression, for example at workplaces, and in addition workplace ergonomics are permanently guaranteed.

### LIST OF REFERENCE SIGNS

10 Arrangement of screens
11 first screen
12 second screen
13 screen housing
14 screen base
15 screen frame
16 display surface
17 vertical frame leg
18 horizontal frame leg
30 clamp component
31 clamp housing
32 clamp leg
33 rod-shaped magnet
35 magnets
36 Gap
40 first hook
41 second hook
51 third screen
52 fourth screen

1. An alignment aid for screens
comprising at least one first connecting means of a first type,
at least one second connecting means of a second type,
wherein the first connecting means of a first screen and the second connecting means of a second screen cooperating with each other for alignment of the screens relative to each other,
wherein the screens are subsequently providable with the alignment aid; and
wherein by the interaction of the first and second connecting means with each other, the other edges of the screens lie securely next to each other.

2. The alignment aid for screens according to claim 1, wherein the connecting means cooperating with each other in a contactless manner.

3. The alignment aid for screens according to claim 2, wherein the first connecting means is a first magnet and the second connecting means is a magnetic material cooperating with the magnet.

4. The alignment aid for screens according to claim 2, wherein the first connecting means is a first magnet and also the second connecting means is a magnet and that the magnets are arranged on the respective screen in such a way that magnets with unequal polarity face each other.

5. The alignment aid according to claim 1, wherein the connecting means are formed as mechanical connecting means.

6. The alignment aid according to claim 5, wherein the first connecting means comprises an extension and the second connecting means comprises a recess in which the extension engages for aligning coupling of the screens.

7. The alignment aid according to claim 6, wherein said first and second connecting means comprise latching means fixing said connecting means to each other.

8. The alignment aid according to claim 1, wherein the connecting means are arrangeable as complementary components on the respective screen.

9. The alignment aid according to claim 8, wherein the connecting means are arrangeable on the respective screen in a frictional and/or positive-locking manner.

10. A screen comprising an alignment aid according to claim 1, wherein the screen carries at least one first and at least one second connecting means intended for cooperating with connecting means of a second screen of a same type,
wherein the screens are subsequently providable with the alignment aid; and
wherein by the interaction of the first and second connecting means with each other, the other edges of the screens lie securely next to each other.

11. The screen according to claim 10, wherein the connecting means are integrated into the screen.

12. The screen according to claim 11, wherein the respective first connecting means and the second connecting means are formed in a rod-shaped and are integrated in the screen frame parallel to a respective edge of the screen.

13. The screen according to claim 10, wherein the first and second connecting means are arranged in the screen frame such that when a plurality of display screens are arranged side by side, complementary connecting means of different display screens face each other.
